(19) United States
(12) Patent Application Publication
(10) Pub. No.: US 2024/0178978 A1
(43) Pub. Date: May 30, 2024

(54) METHODS AND SYSTEMS FOR DETERMINING TRANSMISSION CONFIGURATION INDICATOR STATES

(71) Applicant: ZTE Corporation, Shenzhen (CN)

(72) Inventors: Ke YAO, Shenzhen (CN); Shujuan ZHANG, Shenzhen (CN); Bo GAO, Shenzhen (CN); Chenchen ZHANG, Shenzhen (CN); Fei DONG, Shenzhen (CN)

(21) Appl. No.: 18/533,153

(22) Filed: Dec. 7, 2023

Related U.S. Application Data
(63) Continuation of application No. PCT/CN2022/111555, filed on Aug. 10, 2022.

(51) Int. Cl. H04L 5/00

(52) U.S. Cl. CPC H04L 5/0094; H04L 5/0048; H04L 5/0053

(57) ABSTRACT

Methods and systems for techniques for determining transmission configuration indicator (TCI) states are disclosed. In an implementation, a method of wireless communication includes receiving, by a wireless device, at least one of a first transmission configuration indicator (TCI) state for a first direction transmission or a second TCI state for a second direction transmission, determining, by the wireless device, an indicated TCI state based on the first TCI state for a certain second direction transmission, and performing, by the wireless device, the certain second direction transmission according to the indicated TCI state.

### CROSS-REFERENCE TO RELATED APPLICATIONS

This application is a continuation of International Patent Application No. PCT/CN2022/111555, filed on Aug. 10, 2022, the contents of which are incorporated herein by reference in their entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for determining transmission configuration indicator (TCI) states for a channel state information reference signal (CSI-RS) and a reference signal (RS).

In one aspect, a method of data communication is disclosed. The method includes receiving, by a wireless device, at least one of a first transmission configuration indicator (TCI) state for a first direction transmission or a second TCI state for a second direction transmission, determining, by the wireless device, an indicated TCI state based on the first TCI state for a certain second direction transmission, and performing, by the wireless device, the certain second direction transmission according to the indicated TCI state.

In another aspect, a method of data communication is disclosed. The method includes determining, by a wireless device, a presence of an aperiodic non-zero power (NZP) channel state information reference signal (CSI-RS) associated with a sounding reference signal (SRS) resource, according to an SRS request field in a control information message, determining, by the wireless device, a transmission configuration indicator (TCI) state for the aperiodic NZP CSI-RS according to a predetermined rule, and performing, by the wireless device, the aperiodic NZP CSI-RS based on the TCI state.

In another aspect, a method of data communication is disclosed. The method includes receiving, by a wireless device, a transmission configuration indicator (TCI) state information including at least one reference signal identity (RS ID), and determining, by the wireless device, a reference signal (RS) of a TCI state that is in a determined component carrier (CC) or bandwidth part (BWP) based on a physical cell identity (PCI) related to the TCI state and the at least one RS ID.

In another aspect, a method of data communication is disclosed. The method includes transmitting, by a network node, to a wireless device, at least one of a first transmission configuration indicator (TCI) state for a first direction transmission or a second TCI state for a second direction transmission, and performing, by the network node, a certain second direction transmission according to an indicated TCI state that is determined by the wireless device based on the first TCI state for the certain second direction transmission.

In another aspect, a method of data communication is disclosed. The method includes transmitting, by a network node, to a wireless device, a control information message that includes a sounding reference signal (SRS) request field for the wireless device to determine a presence of an aperiodic non-zero power (NZP) channel state information reference signal (CSI-RS) associated with an SRS resource according to the SRS request field in the control information message and to determine a transmission configuration indicator (TCI) state for the aperiodic NZP CSI-RS according to a predetermined rule, and performing, by the network node, the NZP CSI-RS based on the TCI state.

In another aspect, a method of data communication is disclosed. The method includes transmitting, by a network node, to a wireless device, a transmission configuration indicator (TCI) state information including at least one reference signal identity (RS ID) for the wireless device to determine a reference signal (RS) of a TCI state that is in a determined component carrier (CC) or bandwidth part (BWP) based on a physical cell identity (PCI) related to the TCI state and the at least one RS ID.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an uplink (UL) beam and a downlink (DL) beam between a user equipment (UE) and a base station (BS).

FIG. 4 shows different base stations and different components carrier that belong to one of the base stations.

FIG. 5 shows an example of determined component carriers (CC) based on some embodiments of the disclosed technology.

FIG. 6 shows an example of a process for wireless communication based on some example embodiments of the disclosed technology.

FIG. 7 shows another example of a process for wireless communication based on some example embodiments of the disclosed technology.

FIG. 8 shows another example of a process for wireless communication based on some example embodiments of the disclosed technology.

FIG. 9 shows another example of a process for wireless communication based on some example embodiments of the disclosed technology.

FIG. 10 shows another example of a process for wireless communication based on some example embodiments of the disclosed technology.

FIG. 11 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

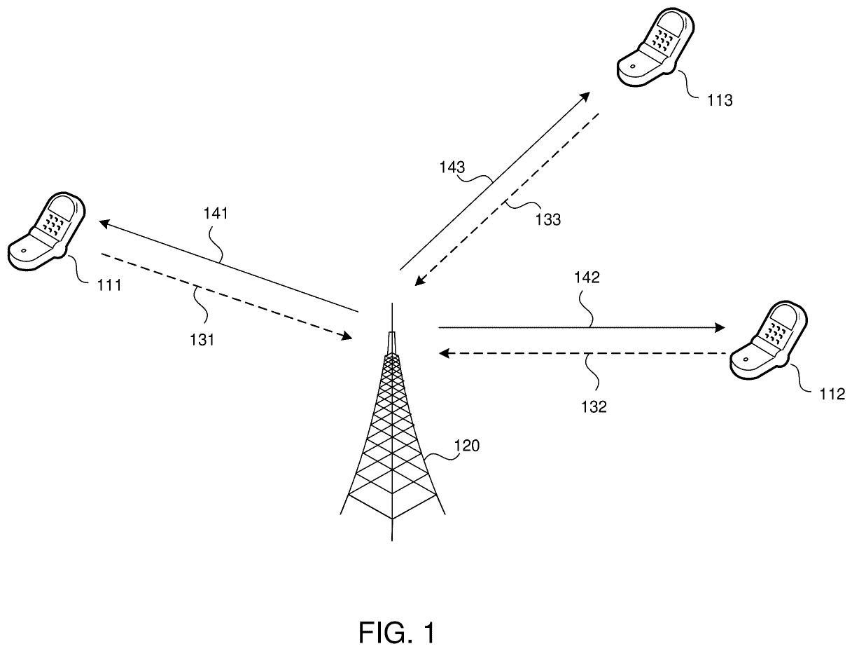

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IOT) device, and so on.

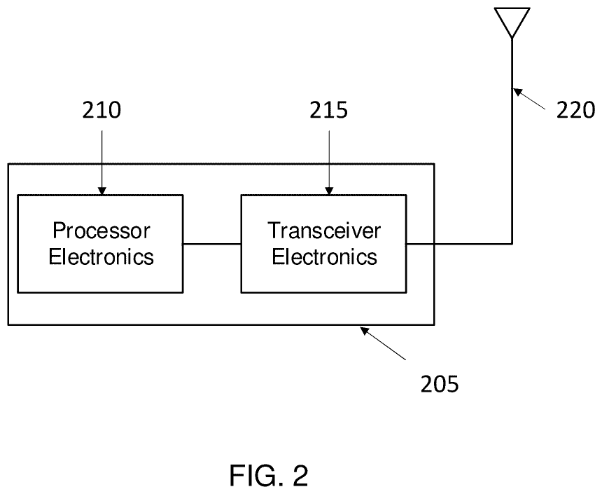

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

The new radio (NR) technology of fifth generation (5G) mobile communication systems is being continuously improved to provide higher-quality wireless communication services. One of the key features of the NR technology of 5G is the use of high frequency bands. High frequency bands have abundant frequency domain resources, but wireless signals in high frequency bands decay quickly and coverage of the wireless signals becomes small. Thus, transmitting signals in a beam mode can concentrate energy in a relatively small spatial range and improve the coverage of the wireless signals in the high frequency bands.

In order to reduce application time for a new beam, a unified beam mechanism is adopted. Once a new beam indicated, it may be applicable for multiple transmissions and/or receptions.

A beam can also be a beam state, which comprises at least one of: a reference signal (RS), a transmission configuration indicator (TCI) state, a spatial relation, quasi-colocation (QCL) information, or precoding information, or an indicator of the above.

In some implementations, gNB (or network, NW) indicates a TCI state. This TCI state can be referred to as an indicated TCI state. The indicated TCI state can be a joint TCI state, which is applied to both downlink (DL) and uplink (UL) communications, or the indicated TCI state can be separate TCI states, which include a TCI state for DL and a TCI state for UL. The indicated TCI state can be determined based on a MAC CE which activates one codepoint of TCI state(s). When medium access control (MAC) control element (CE) is applicable, e.g., a period after hybrid automatic repeat request (HARQ)-acknowledgement (ACK) for reception of the MAC CE, one or more TCI states in the one codepoint in the MAC CE is determined as indicated TCI state(s) and is applicable. In other implementations, a MAC CE activates more than one codepoint of TCI state(s), and then a downlink control information (DCI) indicates one codepoint of TCI state(s) from the plurality of codepoints of TCI state(s) activated by the MAC CE. The one or more TCI states in the one codepoint indicated by the DCI are determined as “indicated” TCI state(s) and are applicable after a period has passed since there was an acknowledgement for reception of the DCI or an acknowledgement for reception of a physical downlink shared channel (PDSCH) scheduled by the DCI.

In some implementations, a UE is configured with the unified TCI state type for a serving cell. The value “Separate” with respect to the TCI state can indicate the corresponding serving cell is configured with at least one DLorJoint-TCIState for DL TCI state, and at least one UL-TCIState for UL TCI state. The value “Joint” with respect to the TCI state can indicate the corresponding serving cell is configured with at least one DLorJoint-TCIState for joint TCI state for UL and DL operation.

The disclosed technology can be implemented in some embodiments to determine TCI state for CSI-RS in some cases, and determine a reference RS (reference state) for a TCI state.

### Embodiment 1

The disclosed technology can be implemented in some embodiments to determine a reference TCI state for CSI-RS, which is associated with a sounding reference signal (SRS) resource set with usage of “non-codebook” (NCB).

Generally, in the case of separate TCI states, UL TCI state can be applied to UL operation, such as physical uplink shared channel (PUSCH), physical uplink control channel (PUCCH) and SRS, and DL TCI state can be applied to DL operation, such as physical downlink control channel (PDCCH), physical downlink shared channel (PDSCH) and channel state information reference signal (CSI-RS).

However, in some cases, the above application scheme may have the following issues.

Case 1: an SRS with usage of “antenna switching” is used for DL operation, but it is assumed to follow UL TCI state according to the current technology.

Case 2: a non-zero power (NZP) CSI-RS associated with an SRS resource set with usage of “non-codebook,” the SRSs are used for uplink transmission, e.g., PUSCH, and thus the beam for the SRS and the related CSI-RS are expected to be aligned with uplink transmissions, but it is assumed to follow DL TCI state according to the current technology.

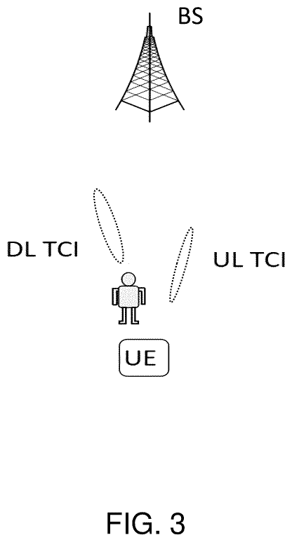

FIG. 3 shows an uplink (UL) beam and a downlink (DL) beam between a user equipment (UE) and a base station (BS).

Separate TCI states can be considered in the following cases:

Case A: there is no reciprocity between DL and UL, or

Case B: a reciprocity between DL and UL exists, but due to, e.g., maximum permitted exposure (MPE), different DL beam pairs from UL beam pairs in a certain direction, as shown in FIG. 3.

At least for Case B, the above issues need to be addressed.

In some embodiments of the disclosed technology, for Case 1, an SRS with usage of “antenna switching” should follow DL TCI state.

In some embodiments of the disclosed technology, for Case 2, an NZP CSI-RS associated with an SRS resource set with usage of “non-codebook” should follow UL TCI state.

In some embodiments of the disclosed technology, in the case of separated DL and UL TCI states, an indicated UL TCI state is determined.

In some embodiments of the disclosed technology, the indicated UL TCI state can be applied to an NZP CSI-RS which is associated with an SRS resource set with usage of NCB.

In some embodiments of the disclosed technology, a UE determines quasi co-location (QCL) information for an NZP CSI-RS resource associated with an SRS resource set with usage of NCB according to the indicated UL TCI state.

In some embodiments of the disclosed technology, a UE may assume that a CSI-RS resource associated with an SRS resource set with usage of NCB is quasi co-located with the RS(s) in the indicated UL TCI state.

### Embodiment 2

The disclosed technology can be implemented in some embodiments to determine a reference TCI state for CSI-RS, e.g., an aperiodic (AP) CSI-RS triggered by an associated SRS resource with usage of non-codebook (NCB).

A TCI state (or a reference TCI state) for a periodic NZP (non-zero power) CSI-RS is configured by radio resource control (RRC) signaling in an NZP CSI-RS resource.

A TCI state (or a reference TCI state) for a semi-persistent NZP CSI-RS is provided by a medium access control (MAC) control element (CE) signaling which activates an NZP CSI-RS. A MAC CE activates a set of NZP CSI-RS resources and provides a TCI state for each NZP CSI-RS resource.

An aperiodic NZP CSI-RS is triggered by a DCI, e.g., DCI format 0_1, or 0_2, with a non-zero channel state information (CSI) request field. The CSI request field indicates a CSI triggering state which is associated with one or more NZP CSI-RS resource sets, and each CSI-RS resource in a CSI-RS resource set is associated with a TCI state as QCL information.

For a non-codebook based transmission, the UE can calculate the precoder used for the transmission of SRS based on a measurement of an associated NZP CSI-RS resource. A UE can be configured with only one NZP CSI-RS resource for the SRS resource set with higher layer parameter usage in SRS-ResourceSet set to “nonCodebook” if configured.

If an aperiodic SRS resource set is configured, the associated NZP-CSI-RS is indicated via SRS request field in DCI format 0_1 and 1_1, as well as DCI format 0_2 (if SRS request field is present) and DCI format 1_2 (if SRS request field is present), where AperiodicSRS-ResourceTrigger and AperiodicSRS-ResourceTriggerList (indicating the association between aperiodic SRS triggering state(s) and SRS resource sets), triggered SRS resource(s) srs-ResourceSetId, csi-RS (indicating the associated NZP-CSI-RS-ResourceId) are higher layers configured in SRS-ResourceSet. The SRS-ResourceSet(s) associated with the SRS request by DCI format 0_1 and 1_1 is/are defined by the entries of the higher layer parameter srs-ResourceSetToAddModList and the SRS-ResourceSet(s) associated with the SRS request by DCI format 0_2 and 1_2 is/are defined by the entries of the higher layer parameter srs-ResourceSetToAddModListDCI-0-2.

If the UE configured with aperiodic SRS associated with aperiodic NZP CSI-RS resource, the presence of the associated CSI-RS is indicated by the SRS request field if the value of the SRS request field is not “00” and if the scheduling DCI is not used for cross carrier or cross bandwidth part scheduling. If UE is configured with minimumSchedulingOffsetK0 in the active DL BWP and the currently applicable minimum scheduling offset restriction K_{0,min} is larger than 0, the UE does not expected to receive the scheduling DCI with the SRS request field value other than “00.” The CSI-RS is located in the same slot as the SRS request field. If the UE configured with aperiodic SRS associated with aperiodic NZP CSI-RS resource, any of the TCI states configured in the scheduled CC shall not be configured with qcl-Type set to “typeD.”

For an AP NZP CSI-RS associated with SRS resource set for NCB, only NZP-CSI-RS-ResourceId is configured. One NZP-CSI-RS-resource ID (NZP-CSI-RS-ResourceId) may belong to multiple NZP-CSI-RS resource sets (NZP-CSI-RS-ResourceSet), and be associated with different TCI states in different CSI-associated report Configuration Information (CSI-AssociatedReportConfigInfo).

For example, the relationship can be:
trigger state ID_1 (RRC configured/MAC CE selected)—NZP-CSI-RS-ResourceSetId_1—NZP-CSI-RS-Resourceld—TCI state ID_1;
trigger state ID_2 (RRC configured/MAC CE selected)—NZP-CSI-RS-ResourceSetId_2—NZP-CSI-RS-Resourceld—TCI state ID_2.

An AP NZP CSI-RS can be triggered by a DCI which triggers an SRS resource set with usage of NCB. In this case, no CSI triggering state ID for CSI-RS is indicated. Thus, it is not clear how to determine TCI state for such AP NZP CSI-RS without a determined CSI triggering state ID. In frequency range 1 (FR1), even if no QCL type D is needed, RS for QCL type A/B/C should still be determined. Therefore, the issue still exists.

Solution without Unified TCI Scheme

In some embodiments of the disclosed technology, a UE can be configured with one NZP CSI-RS resource for the SRS resource set with a higher layer parameter usage in SRS-ResourceSet that is set to “nonCodebook.” For a non-codebook based transmission, the UE can calculate the precoder used for the transmission of SRS based on a measurement of an associated NZP CSI-RS resource.

In some embodiments of the disclosed technology, a UE is configured with an aperiodic SRS associated with an aperiodic NZP CSI-RS resource, the presence of the associated AP NZP CSI-RS is determined according to an SRS request field, e.g., if the value of the SRS request field is not “00.”

In some embodiments of the disclosed technology, the UE may determine a TCI state for the NZP CSI-RS according to at least one of the following rules:
a lowest TCI state ID in a TCI state pool;
a TCI state associated with a CORESET with lowest CORESET ID;
a TCI state associated with the latest PDSCH transmission;
a TCI state associated with the latest CSI-RS transmission;
a TCI state associated with the latest DL transmission, e.g., including PDCCH, PDSCH, or CSI-RS, further the DL transmission is aperiodic transmission;
a TCI state associated with a latest DCI which triggered a CSI request associated with the NZP CSI-RS;
a TCI state associated with the NZP CSI-RS with a lowest configured trigger state ID; or
a TCI state associated with the NZP CSI-RS with lowest CSI-RS resource set ID which includes the NZP CSI-RS ID.
   Solution with Unified TCI

In some embodiments of the disclosed technology, a unified (joint, or UL) TCI state can be applied to CSI-RS, including the cases discussed above.

SRS configuration related embodiments

A UE can be configured with more than one SRS resource sets associated with one usage with different time behaviors. At least one parameter in the more than one SRS resource set with different time behaviors is configured with the same value.

A UE can be configured with one or more SRS resource sets, by a network. Each SRS resource set is associated with a usage that includes at least one of codebook, non-codebook, beam management, or antenna switching. For one usage, more than one SRS resource set can be configured with different time behaviors, which comprise at least one of periodic, aperiodic, or semi-persistent.

At least one parameter in the more than one SRS resource set with different time behaviors is configured with the same value. The parameter may include at least one of usage, power control parameters (open loop power control parameter, e.g., target receive power, PO, pathloss compensation factor, alpha, closed loop power control parameter, e.g., closed loop power control index, or RS for pathloss estimation), part or all of SRS resources in SRS resource list, a number of ports for part or all of SRS resources in SRS resource list, SRS spatial relation for part or all of SRS resources in SRS resource list, whether to share closed loop power control with PUSCH and which closed loop power control of PUSCH is shared, or whether to follow Unified TCI state.

For example, SRS for a usage, e.g., codebook, can be configured with periodic and aperiodic for a UE. The period can be larger for overhead saving. However, an aperiodic SRS can be scheduled dynamically on demand for flexibility.

### Embodiment 3

The disclosed technology can be implemented in some embodiments to determine a reference RS from a neighboring cell for a TCI state

There is more than one carrier (or serving cell, or component carrier (CC)) in carrier aggregation (CA) scenarios. One serving cell is a primary cell, i.e., PCell or SpCell (special cell), the other serving cells are secondary cells, i.e., SCell. For a serving cell, one serving cell ID (or CC ID, e.g., with a value of 0-31) is configured, one physical cell ID (PCID) is configured, e.g., with a value of 0-1007, and a list of additional PCIDs can be configured. An additional PCID can be a value of 1-7, which is identified as a physical cell ID which is different from PCID.

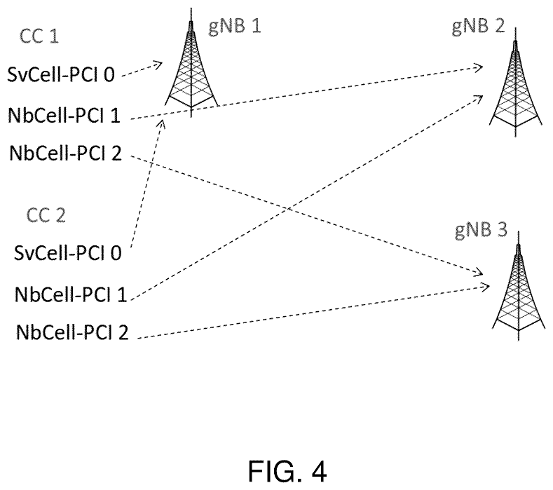

Different physical cell IDs identifies different physical cell entities, e.g., serving cells. A list of additional PCIDs is configured for a serving cell, and can be used to identify neighboring physical cell (NbCell-PCI) entities. A serving cell can be configured with at most 7 additional PCID which indicate different PCID from the PCID for the serving cell itself (SvCell-PCI). As shown in FIG. 4, CC 1 and CC2 belong to gNB 1, each of them can be configured one serving cell PCI and a list of neighboring cell PCI. From perspective of each CC, they may have different set of neighboring cells.

FIG. 4 shows different base stations and different components carrier that belong to one of the base stations.

Referring to FIG. 4, there are first, second and third base stations (gNB1, gNB2, gNB3) and first and second component carriers (CC1, CC2) that belong to the first base station (gNB1).

One serving cell can be configured to support, e.g., at most 4 bandwidth parts (BWPs) for downlink and/or uplink. For each BWP, at least one TCI state can be configured as a TCI state pool (or a list). One TCI state that is identified by a TCI state ID may include one or two QCL information (QCL-info). One QCL-info indicates a reference RS (source RS) which can be a CSI-RS, or an SSB, and identified by CSI-RS resource ID, or SSB ID respectively. If one TCI state is configured with two QCL-info, their QCL types should be different, e.g., one is type D, and the other is type A, type B or type C. A reference RS can be configured with a serving cell ID and a BWP ID to indicate which CC and BWP the reference (or source) RS are communicated on. If a serving cell ID or a BWP ID is absent or not configured for QCL-Type A/D source RS in a QCL-Info of the TCI state, the UE assumes that QCL-Type A/D source RS is configured in the CC/DL BWP where TCI state applies.

The IE TCI-State associates one or two DL reference signals with a corresponding quasi-colocation (QCL) type.

TABLE 1
TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ... ,
  [[
```

| | |
|---|---|
| additionalPCI-r17 AdditionalPCIIndex-r17 | OPTIONAL, -- Need R |
| pathlossReferenceRS-Id-r17 PUSCH-PathlossReferenceRS-Id | OPTIONAL, -- Cond JointTCI |
| ul-powerControl-r17 Uplink-powerControlId-r17 | OPTIONAL -- Cond |

JointTCI
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...,
}

The disclosed technology can be implemented in some embodiments to configure an additional PCI for a TCI state.

The disclosed technology can be implemented in some embodiments to determine a reference (or source) RS from a neighboring cell.

In some embodiments of the disclosed technology, an additional PCI in a TCI state is used to indicate an additional PCI different from serving cell PCI.

In some embodiments of the disclosed technology, the additional PCI is an additional PCI of a determined serving cell.

In some implementations, the determined serving cell can be determined based on a cell field in the corresponding QCL-info, e.g., if the cell field is present.

In some implementations, the determined serving cell can be a serving cell to which the TCI state is applied, e.g., if the cell field is absent in the corresponding QCL-info.

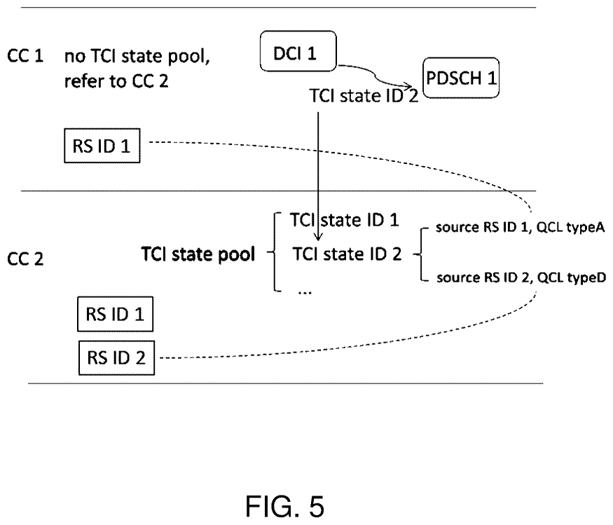

FIG. 5 shows an example of determined component carriers (CC) based on some embodiments of the disclosed technology.

For example, as shown in FIG. 5, a UE is configured a TCI state pool in CC 2. The TCI state includes at least one TCI state, and among them, a TCI state ID 2 includes two QCL-Info. The first QCL-Info includes source RS ID 1 with QCL typeA and no Cell is configured, the second QCL-Info includes source RS ID 2 with QCL typeD and a CC 2. If a TCI state is applied in CC1 that has no TCI state pool configured and is configured with a reference CC2, the TCI state is interpreted according to a TCI state pool configured in CC2. If TCI state ID 2 is indicated, the CC of source RS ID 1 should be determined as the CC to which the TCI state applies, i.e., CC1 for DCI 1 or PDSCH 1 transmission on CC1, or CC2 for a DL or UL transmission on CC2 since the CC is not configured for the source RS. The CC for source RS ID 2 should be determined as the CC which cell field in the QCL-Info indicates, i.e., CC2.

In some implementations, the additional PCI is used for determining information of a reference RS (or source RS) if the reference RS is an SSB in the corresponding QCL-info.

In some implementations, an additional PCT (additionalPCI) indicates that this TCI state refers to an additional PCI different from a serving cell PCI, as configured in ServingCellConfig of a serving cell determined by the cell field in QCL-info including a SSB as the reference signal.

In some embodiments of the disclosed technology, an NZP CSI-RS associated with an SRS resource set with usage of “non-codebook” should follow UL TCI state.

The disclosed technology can be implemented in some embodiments to provide rules for determining reference TCI state for CSI-RS i.e., aperiodic (AP) CSI-RS triggered by the associated SRS resource with usage of non-codebook

In some embodiments of the disclosed technology, reference RS (or source RS) is determined according to additional PCI in a TCI state and a determined Cell.

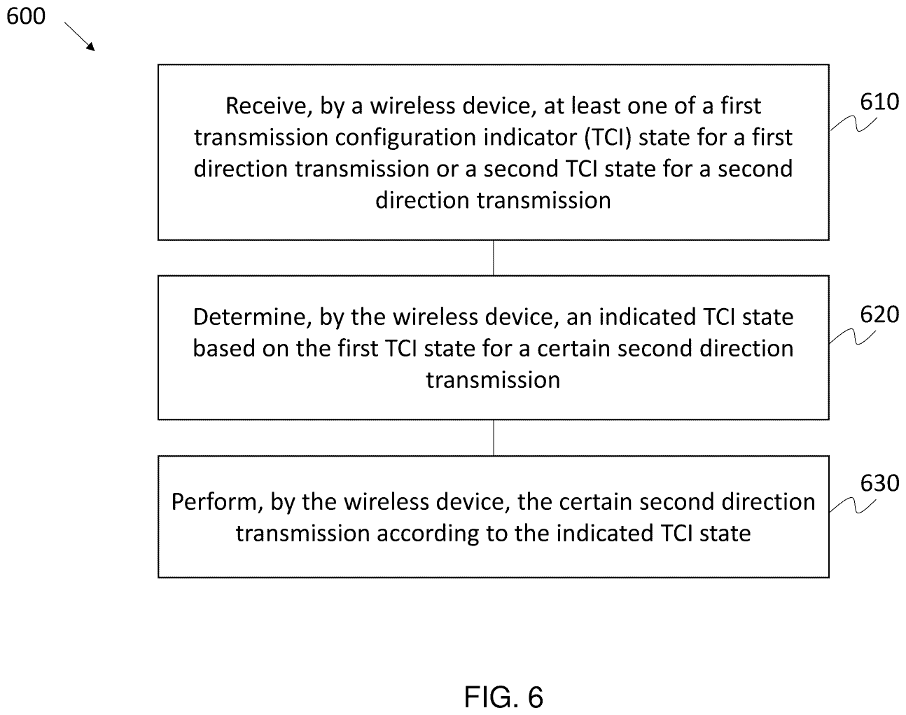

FIG. 6 shows an example of a process for wireless communication based on some example embodiments of the disclosed technology.

In some implementations, the process 600 for wireless communication may include, at 610, receiving, by a wireless device, at least one of a first transmission configuration indicator (TCI) state for a first direction transmission or a second TCI state for a second direction transmission, at 620, determining, by the wireless device, an indicated TCI state based on the first TCI state for a certain second direction transmission, and at 630, performing, by the wireless device, the certain second direction transmission according to the indicated TCI state.

In some embodiments of the disclosed technology, a transmission configuration indicator (TCI) state may be a “beam state” which indicates a beam, a quasi-co-location (QCL) state, a spatial relation state (also referred to as spatial relation information state), a reference signal (RS), a spatial filter, or pre-coding information. The RS can be a synchronization signal block (SSB), channel state information reference signal (CSI-RS), or sounding reference signal (SRS). a TCI state can be a beam state, or a RS resource indication.

In some implementations, the certain second direction transmission comprises at least one of a non-zero power (NZP) channel state information reference signal (CSI-RS) associated with an SRS with usage of non-codebook, or an SRS with usage of antenna switching. In one example, the SRS can be an SRS resource, or an SRS resource in an SRS resource set. In one example, the SRS with a usage can be an SRS resource in an SRS resource set associated/configured with the usage. The usage may include at least one of codebook, non-codebook, antenna switching, or beam management.

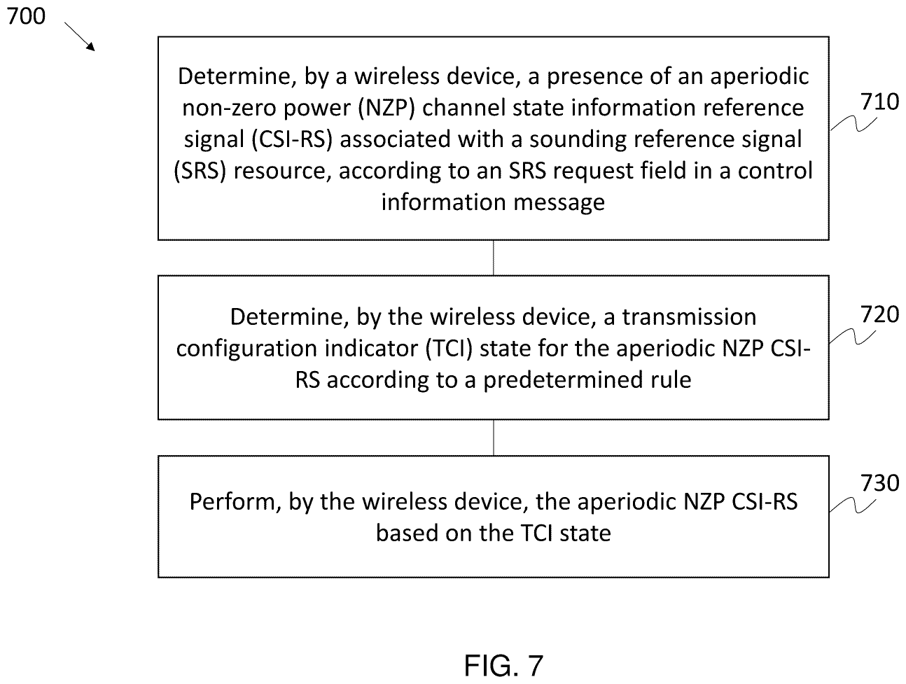

FIG. 7 shows another example of a process for wireless communication based on some example embodiments of the disclosed technology.

In some implementations, the process 700 for wireless communication may include, at 710, determining, by a wireless device, a presence of an aperiodic non-zero power (NZP) channel state information reference signal (CSI-RS) associated with a sounding reference signal (SRS) resource, according to an SRS request field in a control information message, at 720, determining, by the wireless device, a transmission configuration indicator (TCI) state for the aperiodic NZP CSI-RS according to a predetermined rule, and at 730, performing, by the wireless device, the aperiodic NZP CSI-RS based on the TCI state.

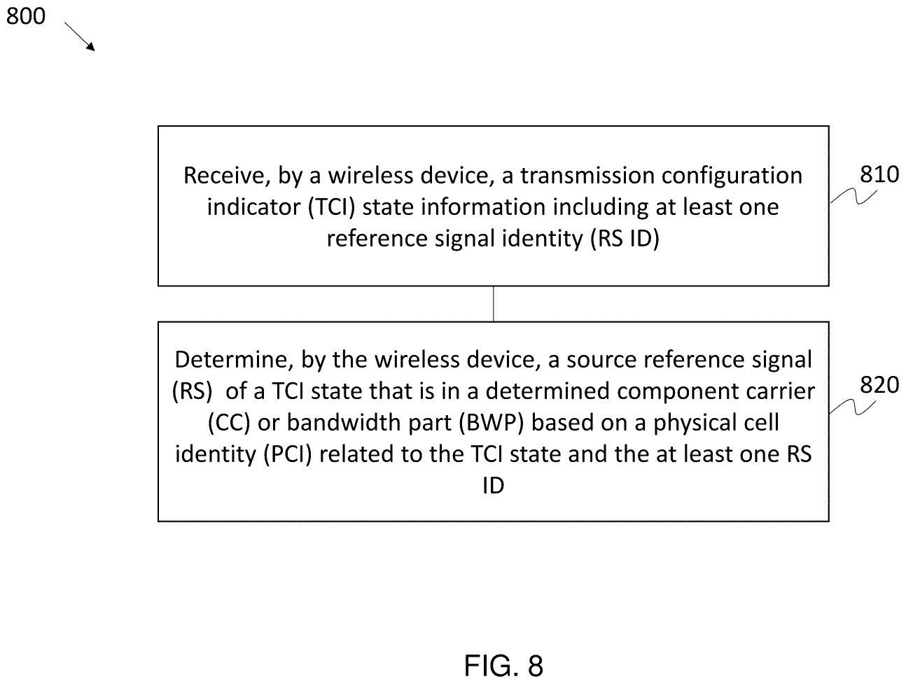

FIG. 8 shows another example of a process for wireless communication based on some example embodiments of the disclosed technology.

In some implementations, the process 800 for wireless communication may include, at 810, receiving, by a wireless device, a transmission configuration indicator (TCI) state information including at least one reference signal identity (RS ID), and at 820, determining, by the wireless device, a source reference signal (RS) of a TCI state that is in a determined component carrier (CC) or bandwidth part (BWP) based on a physical cell identity (PCI) related to the TCI state and the at least one RS ID.

In one example, the RS in a TCI state may be a source RS, or a reference RS.

In one example, the RS may include at least one of a synchronization signal block (SSB), a channel state information reference signal (CSI-RS), or a sounding reference signal (SRS).

In one example, the PCI related to the TCI state may include an additional PCI in the TCI state, or a PCI for a serving cell where the TCI state is configured.

In one example, the determined CC or BWP may include a CC or BWP indicated by a serving cell ID or a BWP ID corresponding to the RS, a CC or BWP indicated by a serving cell ID or a BWP ID corresponding to the RS that is an SSB, a CC or BWP where the TCI state applies, or a CC or BWP where the TCI state applies, in response to a serving cell ID or a BWP ID corresponding to the RS absent in the TCI state.

In one example, when the bwp-id or cell for QCL-TypeA/D source RS in a QCL-Info of the TCI state configured with DLorJointTCIState is not configured, the UE assumes that QCL-TypeA/D source RS is configured in the CC/DL BWP where the TCI state applies. For a source RS being a SSB, the UE assumes that source RS is configured in the CC/BWP where the TCI state applies with an additional PCI in the TCI state.

In one example, for a source RS being a SSB, the UE assumes that source RS is configured in the CC/BWP indicated by a serving cell ID or a BWP ID in a QCL-Info which includes the source RS.

In one example, an additional PCI in a TCI state indicates a physical cell IDs (PCI) of an SSB which is a reference signal.

In one example, an additional PCI in a TCI state indicates a PCI of the source RS in QCL-Info being an SSB.

In one example, an additional PCI in a TCI state indicates a PCI of a serving cell for a source RS in QCL-Info being an SSB. The serving cell is determined by the cell field in QCL-info including a SSB as the reference signal, or the serving cell is determined by a serving cell where the TCI state is applied, e.g., when the cell field in TCI state is not present.

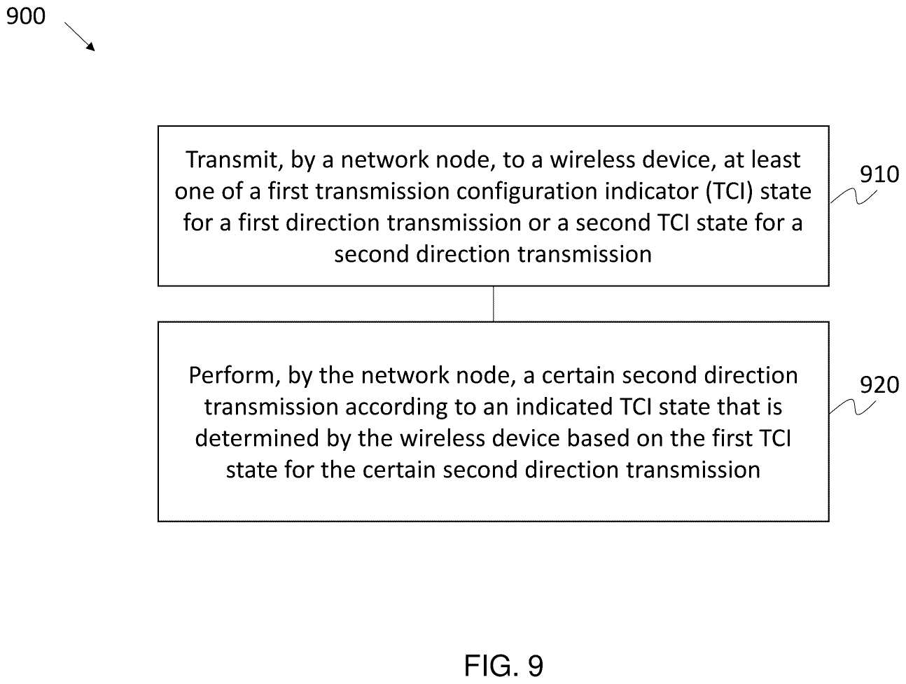

FIG. 9 shows another example of a process for wireless communication based on some example embodiments of the disclosed technology.

In some implementations, the process 900 for wireless communication may include, at 910, transmitting, by a network node, to a wireless device, at least one of a first transmission configuration indicator (TCI) state for a first direction transmission or a second TCI state for a second direction transmission, and at 920, performing, by the network node, a certain second direction transmission according to a indicated TCI state that is determined by the wireless device based on the first TCI state for the certain second direction transmission.

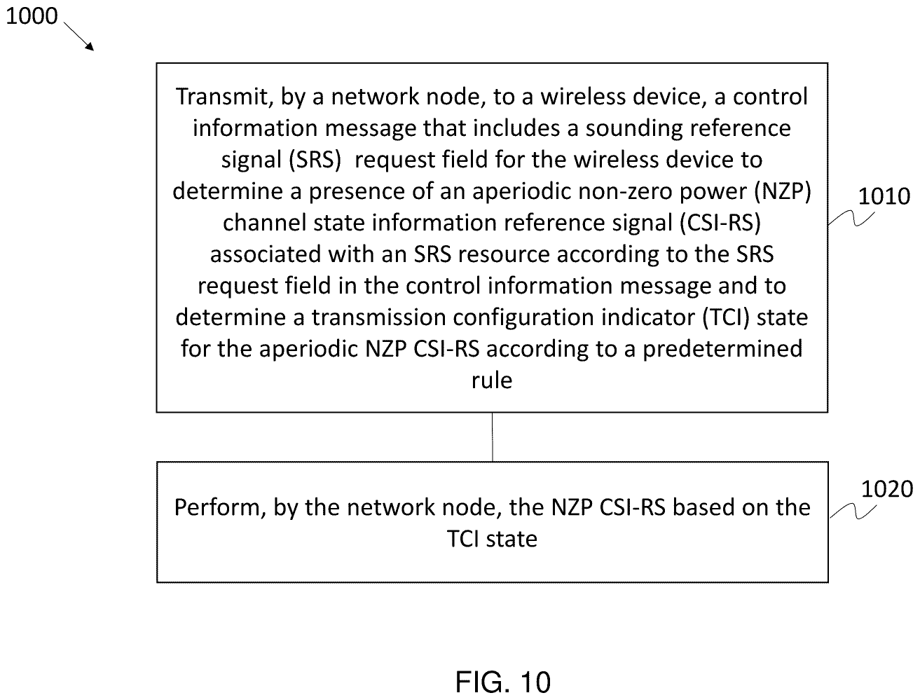

FIG. 10 shows another example of a process for wireless communication based on some example embodiments of the disclosed technology.

In some implementations, the process 1000 for wireless communication may include, at 1010, transmitting, by a network node, to a wireless device, a control information message that includes a sounding reference signal (SRS) request field for the wireless device to determine a presence of an aperiodic non-zero power (NZP) channel state information reference signal (CSI-RS) associated with an SRS resource according to the SRS request field in the control information message and to determine a transmission configuration indicator (TCI) state for the aperiodic NZP CSI-RS according to a predetermined rule, and at 1020, performing, by the network node, the NZP CSI-RS based on the TCI state.

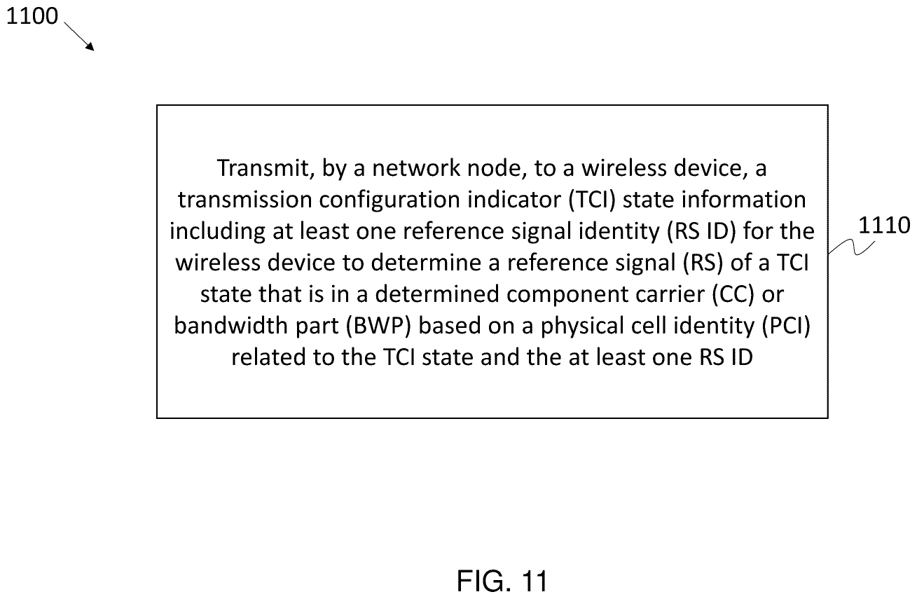

FIG. 11 shows another example of a process for wireless communication based on some example embodiments of the disclosed technology.

In some implementations, the process 1100 for wireless communication may include, at 1110, transmitting, by a network node, to a wireless device, a transmission configuration indicator (TCI) state information including at least one reference signal identity (RS ID) for the wireless device to determine a reference signal (RS) of a TCI state that is in a determined component carrier (CC) or bandwidth part (BWP) based on a physical cell identity (PCI) related to the TCI state and the at least one RS ID.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a wireless device, at least one of a first transmission configuration indicator (TCI) state for a first direction transmission or a second TCI state for a second direction transmission; determining, by the wireless device, an indicated TCI state based on the first TCI state for a certain second direction transmission; and performing, by the wireless device, the certain second direction transmission according to the indicated TCI state.

Clause 2. The method of clause 1, wherein the first direction transmission comprises an uplink transmission, and the second direction transmission includes a downlink transmission, wherein the uplink transmission includes at least one of a transmission on a physical uplink control channel (PUCCH), a transmission on a physical uplink shared channel (PUSCH), or a sounding reference signal (SRS), and the downlink transmission includes at least one of a transmission on a physical downlink control channel (PDCCH), a transmission on a physical downlink shared channel (PDSCH), or a channel state information reference signal (CSI-RS).

Clause 3. The method of clause 1, wherein the first direction transmission comprises a downlink transmission, and the second direction transmission includes an uplink transmission, wherein the uplink transmission includes at least one of a transmission on a PUCCH, a transmission on a PUSCH, or an SRS, and the downlink transmission includes at least one of a transmission on a PDCCH, a transmission on a PDSCH, or a CSI-RS.

Clause 4. The method of any of clauses 1-3, wherein the certain second direction transmission comprises at least one of a non-zero power (NZP) channel state information reference signal (CSI-RS) associated with an SRS with usage of non-codebook, or an SRS with usage of antenna switching.

Clause 5. The method of any of clauses 1-3, wherein the indicated TCI state comprises: an uplink TCI state corresponding to the certain second direction transmission in a case that the certain second direction transmission is a downlink transmission; or a downlink TCI state corresponding to the certain second direction transmission in a case that the certain second direction transmission is an uplink transmission.

Clause 6. The method of clause 1, further comprising: determining, by the wireless device, quasi-colocation information for the certain second direction transmission according to the indicated TCI state; determining, by the wireless device, the certain second direction transmission being quasi co-located with a reference signal (RS) in the indicated TCI state; determining, by the wireless device, a spatial relation for the certain second direction transmission according to the indicated TCI state; or determining, by the wireless device, a spatial relation for the certain second direction transmission according to a reference to an RS with quasi co-located (QCL)-type D (QCL-type D) in the indicated TCI state.

Clause 7. The method of clauses 1, further comprising: determining, by the wireless device, according to a type of unified TCI state having separate states, the indicated TCI state based on the first TCI state for the certain second direction transmission.

Clause 8. A method of wireless communication, comprising: determining, by a wireless device, a presence of an aperiodic non-zero power (NZP) channel state information reference signal (CSI-RS) associated with a sounding reference signal (SRS) resource, according to an SRS request field in a control information message; determining, by the wireless device, a transmission configuration indicator (TCI) state for the aperiodic NZP CSI-RS according to a predetermined rule; and performing, by the wireless device, the aperiodic NZP CSI-RS based on the TCI state.

Clause 9. The method of clause 8, wherein the performing of the aperiodic NZP CSI-RS based on the TCI state comprises: assuming, by the wireless device, the aperiodic NZP CSI-RS to be quasi co-located with an RS in the TCI state; or receiving, by the wireless device, the aperiodic NZP CSI-RS quasi co-located with an RS in the TCI state.

Clause 10. The method of clause 8, wherein the control information message includes downlink control information (DCI).

Clause 11. The method of clause 8, wherein the predetermined rule includes at least one of: a lowest transmission configuration indicator (TCI) state identity (ID) in a TCI state pool; a TCI state associated with a control resource set (CORESET) with a lowest CORESET ID; a TCI state associated with a CORESET with a lowest CORESET ID in the latest slot; a TCI state associated with a latest physical downlink shared channel (PDSCH) transmission; a TCI state associated with a latest channel state information reference signal (CSI-RS) transmission; a TCI state associated with a latest downlink (DL) transmission; a TCI state which is indicated as a unified TCI state for downlink transmission; a TCI state associated with a latest uplink (UL) transmission; a TCI state which is indicated as a unified TCI state for uplink transmission; a TCI state associated with a latest downlink control information (DCI) that triggers a channel state information (CSI) request associated with an NZP CSI-RS; a TCI state associated with the NZP CSI-RS with a lowest configured trigger state ID; or a TCI state associated with the NZP CSI-RS with a lowest CSI-RS resource set ID among CSI-RS resource sets which include the NZP CSI-RS ID.

In some implementations, the TCI state pool can be a set of TCI states for uplink transmission. In some implementations, the TCI state pool can be a set of TCI states for downlink or joint transmission.

In some implementations, the trigger state can be CSI Aperiodic Trigger State. In some implementations, an NZP CSI-RS is determined by a NZP CSI-RS resource ID associated with a SRS resource set comprising the SRS resource. In some implementations, an NZP CSI-RS resource can be included in multiple CSI-RS resource sets. For a CSI Aperiodic Trigger State, at least one CSI-RS resource set is associated, and each CSI-RS resource in the CSI-RS resource set is associated with a TCI state. Therefore, a NZP CSI-RS resource ID may be included in one or more NZP CSI-RS resource sets, and further associated with one or more trigger state. In different trigger state, different TCI states may be associated for one NZP CSI-RS resource ID. In above case, no trigger state is indicated, a lowest trigger state ID among trigger states associated for the NZP CSI-RS resource ID can be used to determine a TCI state for the NZP CSI-RS resource. Alternatively, a trigger state with a lowest CSI-RS resource set ID among CSI-RS resource sets including the NZP CSI-RS resource ID and associated with any trigger state is used to determine a TCI state for the NZP CSI-RS resource. The lowest ID is discussed by way of example, and thus it can be replaced by a highest ID, a largest ID, a smallest ID, a predetermined/configured value ID.

Clause 12. The method of clause 11, wherein the DL transmission includes at least one of physical downlink control channel (PDCCH), physical downlink shared channel (PDSCH), or CSI-RS, or the DL transmission includes an aperiodic transmission.

Clause 13. The method of clause 11, wherein the UL transmission includes at least one of physical uplink control channel (PUCCH), physical uplink shared channel (PUSCH), or SRS.

Clause 14. A method of wireless communication, comprising: receiving, by a wireless device, a transmission configuration indicator (TCI) state information including at least one reference signal identity (RS ID); and determining, by the wireless device, a reference signal (RS) of a TCI state that is in a determined component carrier (CC) or bandwidth part (BWP) based on a physical cell identity (PCI) related to the TCI state and the at least one RS ID.

Clause 15. The method of clause 14, wherein the RS comprises at least one of a synchronization signal block (SSB), a channel state information reference signal (CSI-RS), or a sounding reference signal (SRS).

Clause 16. The method of clause 14, wherein the PCI related to the TCI state comprises an additional PCI in the TCI state, or a PCI for a serving cell where the TCI state is configured.

Clause 17. The method of clause 14, wherein the determined CC or BWP comprises: a CC or BWP indicated by a serving cell ID or a BWP ID corresponding to the RS; a CC or BWP indicated by a serving cell ID or a BWP ID corresponding to the RS that is an SSB; a CC or BWP where the TCI state applies; or a CC or BWP where the TCI state applies, in response to a serving cell ID or a BWP ID corresponding to the RS being absent in the TCI state.

Clause 18. A method of wireless communication, comprising: transmitting, by a network node, to a wireless device, at least one of a first transmission configuration indicator (TCI) state for a first direction transmission or a second TCI state for a second direction transmission; and performing, by the network node, a certain second direction transmission according to an indicated TCI state that is determined by the wireless device based on the first TCI state for the certain second direction transmission.

Clause 19. A method of wireless communication, comprising: transmitting, by a network node, to a wireless device, a control information message that includes a sounding reference signal (SRS) request field for the wireless device to determine a presence of an aperiodic non-zero power (NZP) channel state information reference signal (CSI-RS) associated with an SRS resource according to the SRS request field in the control information message and to determine a transmission configuration indicator (TCI) state for the aperiodic NZP CSI-RS according to a predetermined rule; and performing, by the network node, the NZP CSI-RS based on the TCI state.

Clause 20. A method of wireless communication, comprising: transmitting, by a network node, to a wireless device, a transmission configuration indicator (TCI) state information including at least one reference signal identity (RS ID) for the wireless device to determine a reference signal (RS) of a TCI state that is in a determined component carrier (CC) or bandwidth part (BWP) based on a physical cell identity (PCI) related to the TCI state and the at least one RS ID.

Clause 21. An apparatus for wireless communication comprising a processor that is configured to carry out the method of any of clauses 1 to 20.

Clause 22. A non-transitory computer readable medium having code stored thereon, the code when executed by a processor, causing the processor to implement a method recited in any of clauses 1 to 20.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1-13. (canceled)

14. A method of wireless communication, comprising:
receiving, by a wireless device, a transmission configuration indicator (TCI) state information including at least one reference signal identity (RS ID); and
determining, by the wireless device, a reference signal (RS) of a TCI state that is in a determined component carrier (CC) or bandwidth part (BWP) based on a physical cell identity (PCI) related to the TCI state and the at least one RS ID.

15. The method of claim 14, wherein the RS comprises at least one of a synchronization signal block (SSB), a channel state information reference signal (CSI-RS), or a sounding reference signal (SRS).

16. The method of claim 14, wherein the PCI related to the TCI state comprises an additional PCI in the TCI state, or a PCI for a serving cell where the TCI state is configured.

17. The method of claim 14, wherein the determined CC or BWP comprises:
a CC or BWP indicated by a serving cell ID or a BWP ID corresponding to the RS;
a CC or BWP indicated by a serving cell ID or a BWP ID corresponding to the RS that is an SSB;
a CC or BWP where the TCI state applies; or
a CC or BWP where the TCI state applies, in response to a serving cell ID or a BWP ID corresponding to the RS being absent in the TCI state.

18-20. (canceled)

21. An apparatus for wireless communication comprising a processor that is configured to carry out a method, comprising:
receiving, by a wireless device, a transmission configuration indicator (TCI) state information including at least one reference signal identity (RS ID); and
determining, by the wireless device, a reference signal (RS) of a TCI state that is in a determined component carrier (CC) or bandwidth part (BWP) based on a physical cell identity (PCI) related to the TCI state and the at least one RS ID.

22. (canceled)

23. The apparatus of claim 21, wherein the RS comprises at least one of a synchronization signal block (SSB), a channel state information reference signal (CSI-RS), or a sounding reference signal (SRS).

24. The apparatus of claim 21, wherein the PCI related to the TCI state comprises an additional PCI in the TCI state, or a PCI for a serving cell where the TCI state is configured.

25. The apparatus of claim 21, wherein the determined CC or BWP comprises:
a CC or BWP indicated by a serving cell ID or a BWP ID corresponding to the RS;
a CC or BWP indicated by a serving cell ID or a BWP ID corresponding to the RS that is an SSB;
a CC or BWP where the TCI state applies; or
a CC or BWP where the TCI state applies, in response to a serving cell ID or a BWP ID corresponding to the RS being absent in the TCI state.

26. A method of wireless communication, comprising:
receiving, by a wireless device, a transmission configuration indicator (TCI) state information including at least one reference signal identity (RS ID); and
determining, by the wireless device, a reference signal (RS) of a TCI state that is in a determined component carrier (CC) based on a physical cell identity (PCI) related to the TCI state and the at least one RS ID.

27. The method of claim 14, wherein the RS comprises a synchronization signal block (SSB).

28. The method of claim 14, wherein the PCI related to the TCI state comprises an additional PCI in the TCI state.

29. The method of claim 14, wherein the determined CC comprises:
a CC indicated by a serving cell ID corresponding to the RS that is an SSB.

30. The method of claim 14, wherein the determined CC comprises:
a CC where the TCI state applies, in response to a serving cell ID or a BWP ID corresponding to the RS being absent in the TCI state.
